(19) United States
(12) Patent Application Publication
(10) Pub. No.: US 2025/0289689 A1
(43) Pub. Date: Sep. 18, 2025

(54) VOCATIONAL VEHICLE WITH ALL-ELECTRIC CRANE ASSEMBLY

(71) Applicant: Oshkosh Corporation, Oshkosh, WI (US)

(72) Inventors: Kevin Michael Bell, Mason City, IA (US); Glen Ashdown, Oshkosh, WI (US)

(73) Assignee: Oshkosh Corporation, Oshkosh, WI (US)

(21) Appl. No.: 19/078,205

(22) Filed: Mar. 12, 2025

Related U.S. Application Data
(60) Provisional application No. 63/564,821, filed on Mar. 13, 2024.

(51) Int. Cl. B66C 23/38

(52) U.S. Cl. CPC B66C 23/38; B66C 2700/0364; B66C 2700/08

(57) ABSTRACT

A vehicle includes a chassis supporting a plurality of wheels, a prime mover supported by the chassis, and a vehicle body supported by the chassis and including a main body and a cab. A boom assembly is coupled to the main body, including an electric actuator and an electric motor, and an electrical accessory equipment system is also coupled to the main body. The electrical accessory equipment system comprises one or more batteries and an electric power control box housing a power conditioner that is configured to supply power from the one or more batteries to the electric actuator and/or the electric motor.

### CROSS-REFERENCE TO RELATED APPLICATIONS

This Application claims the benefit of and priority to U.S. Provisional Application No. 63/564,821, filed Mar. 13, 2024, the entire contents of which are hereby incorporated by reference herein.

### BACKGROUND

The present disclosure relates generally to the field of cranes and other lifting machines designed to raise, lower, load, unload, or otherwise move a load such as cargo, materials, and other items.

### SUMMARY

One exemplary embodiment relates to a vehicle. The vehicle includes a chassis supporting a plurality of wheels, a prime mover supported by the chassis, and a vehicle body supported by the chassis and including a main body and a cab. A boom assembly is coupled to the main body, including an electric actuator and an electric motor, and an electrical accessory equipment system is also coupled to the main body. The electrical accessory equipment system comprises one or more batteries and an electric power control box housing a power conditioner that is configured to supply power from the one or more batteries to the electric actuator and/or the electric motor.

Another exemplary embodiment relates to a mobile crane system for a vocational vehicle. The mobile crane system includes a boom assembly configured to be coupled to the vocational vehicle and including an electric actuator and an electric motor. An electrical accessory equipment system is configured to be coupled to the vocational vehicle. The electrical accessory equipment system includes one or more batteries and an electric power control box housing a power conditioner that is configured to supply power from the one or more batteries to the electric actuator and/or the electric motor.

Yet another exemplary embodiment relates to a method of manufacturing a vehicle. The method includes coupling a boom assembly comprising an electric actuator and an electric motor to a main body of a vehicle, the main body supported by a chassis of the vehicle. Additionally, the method includes coupling an electrical accessory equipment system to the main body and the boom assembly. The electrical accessory equipment system includes one or more batteries and an electric power control box housing a power conditioner that is configured to supply power from the one or more batteries to the electric actuator and/or the electric motor.

An additional exemplary embodiment relates to and electric crane vehicle. The electric crane vehicle includes a prime mover, a chassis supporting a plurality of wheels, and a vehicle body supported by the chassis and comprising a main body and a cab. A boom assembly is coupled to the main body, and an electrical system is coupled to the main body. The electrical system comprises an air compressor, an electric power control box, and one or more batteries. The air compressor, the electric power control box, and the one or more batteries are positioned inline and are arranged along a top surface of the main body, proximate to a side of the main body, and positioned substantially in between the cab and the boom assembly.

The invention is capable of other embodiments and of being carried out in various ways. Alternative exemplary embodiments relate to other features and combinations of features as may be recited herein.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a crane vehicle, according to an exemplary embodiment;

FIG. 2 a perspective view of a boom assembly of the crane vehicle of FIG. 1, according to an exemplary embodiment;

FIG. 3 is a detail view of motor controller modules of the boom assembly of FIG. 2, according to an exemplary embodiment;

FIG. 4 is a perspective view of the crane vehicle of FIG. 1, according to an exemplary embodiment; and

FIG. 5 is a perspective view of the crane vehicle of FIG. 1 and the boom assembly of FIG. 2, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the FIGURES generally, the various exemplary embodiments disclosed herein relate to a vocational vehicle that includes an all-electric crane system. The vocational vehicle of the present disclosure includes an onboard energy storage device, such as a battery, that provides power to auxiliary equipment, including the crane. In some embodiments, the onboard energy storage device may also be configured to power or supplement power provided to a motor that produces rotational power to drive the vehicle. The energy storage device, which includes a battery or battery assembly, can also be used to provide power to different subsystems on the electric crane system. The electric crane system also includes all-electric actuators to power movement of the crane. Such an arrangement provides a unique alternative to conventional boom truck systems and eliminates the need for, and potential environmental implications associated with, the use of oils and/or fuel to power the crane. Such an arrangement can also reduce energy consumption by eliminating the need for operating a prime mover of the vehicle, such as an internal combustion engine to power movement of the crane.

### Crane Assembly

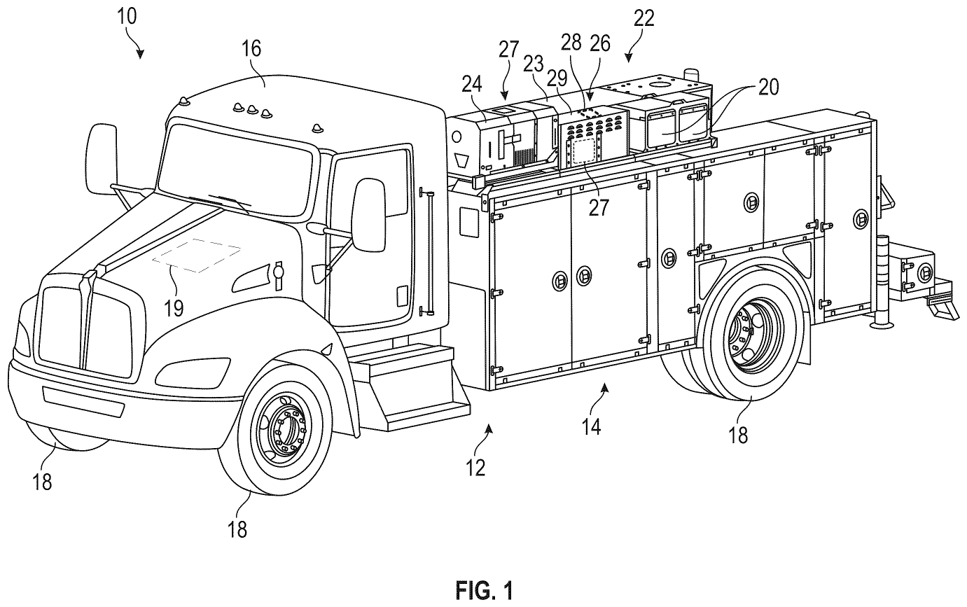

Referring to FIG. 1, a vehicle, shown as vehicle 10 (e.g., a vocational vehicle, a mobile crane, a boom truck, a mechanics truck, etc.), includes a chassis (e.g., frame, etc.) and a body assembly, shown as body assembly 12, coupled to the chassis. The body assembly 12 defines a main body 14 and a cab 16. The cab 16 is coupled to a front end of the chassis, and includes various components to facilitate operation of the vehicle 10 by an operator (e.g., a seat, a steering wheel, controls, etc.) as well as components that can execute commands automatically to control different subsystems within the vehicle 10 (e.g., computers, controllers, processing units, etc.). The vehicle 10 further includes a prime mover coupled to the chassis at a position beneath the cab 16. The prime mover provides power to a plurality of motive members, for example, shown as wheels 18, and to other systems of the vehicle 10 (e.g., a pneumatic system, etc.). In one embodiment, the prime mover includes one or more electric motors 19 coupled to the chassis. The electric motor(s) 19 may consume electrical power from an on-board energy storage device (e.g., one or more batteries 20, ultra-capacitors, etc.), from an on-board generator (e.g., an internal combustion engine and alternator), and/or from an external power source (e.g., overhead power lines, power rails, etc.) and provide power to the systems of the vehicle 10. In some examples, the on-board energy storage device is a plurality of rechargeable lithium-ion battery cells.

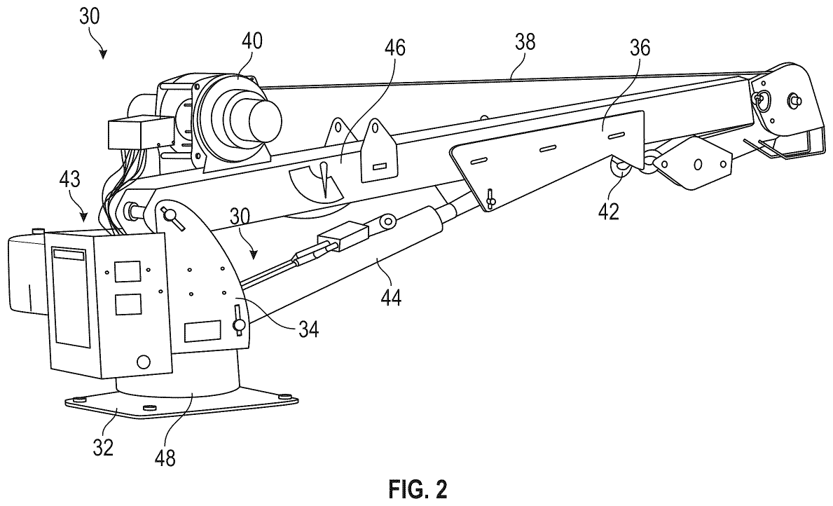

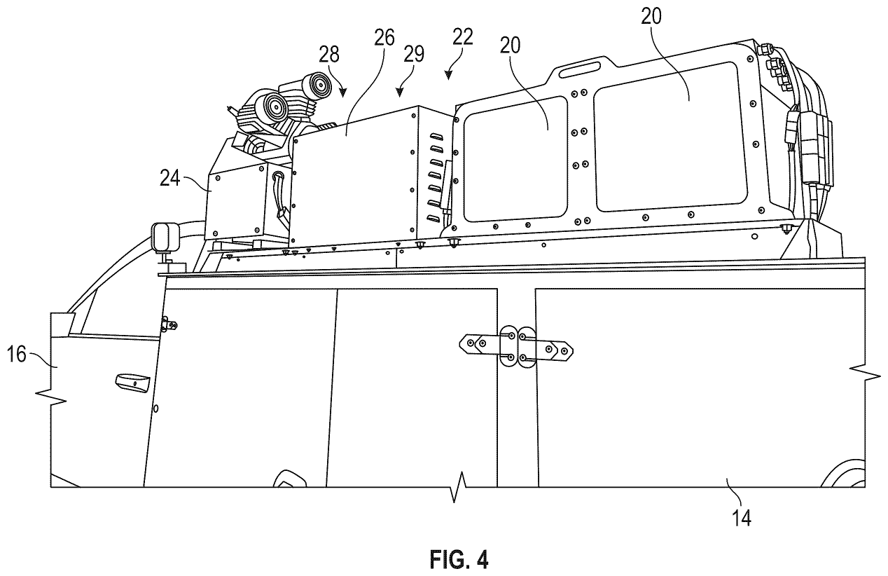

Referring to FIGS. 1 and 4, the main body 14 of the vehicle 10 includes an Electrified Power Equipment (EPEQ) system 22 (e.g., an electrical power equipment system, an electrical accessory equipment system, an electrical crane equipment system, etc.) provided within an EPEQ housing 23. In some embodiments, the EPEQ system 22 is a dedicated accessory power system that can be retrofit onto an existing vocational vehicle to provide portable crane platform, air compressor, or other accessory system support. Such a system can also enable operation of the crane and/or other accessory equipment when a prime mover of the vocational vehicle is shut down (e.g., at a worksite, etc.). Such an arrangement also enables power to be provided to the accessory systems (e.g., the boom assembly) at a higher voltage than the native vehicle electrical system (e.g., at 48V instead of 12V). Referring to FIG. 2, a detail view of a portion of the vehicle 10 is shown that may be used with or as part of the EQEQ system 22. FIGS. 1 and 4 depicts the EPEQ system 22, which includes the batteries 20 (e.g., one or more 48V batteries, etc.). FIGS. 1 and 4 also depict an air compressor 24.

The EPEQ system 22 includes an electric power control box 26 (discussed further herein), which may include a controller 27, a body power inverter 28 (e.g., a 48V to 12V inverter, etc.), and/or a charger 29 (e.g., a 120V charger, etc.). In some embodiments, as further described herein, some components such as one or more electric actuators, may be controlled by one or more motor controllers positioned on the boom assembly. The charger 29 may be selectively electrically coupled to an external energy source (e.g., a power grid, a generator, a charging station, etc.) to deliver electrical energy to the vehicle 10 to charge the batteries 20 and/or directly power one or more components of the vehicle 10. The main body 14 of the vehicle 10 also includes the batteries 20 (e.g., one or more 48V batteries, etc.), which may form part of the EPEQ system 22 in some embodiments, and an air compressor 24. The air compressor 24 may be diesel, gas, or electrically-operated.

The batteries 20 can be rechargeable lithium-ion batteries, for example. In some embodiments, the batteries 20 are configured to supply electrical power to the prime mover, which includes one or more electric motors 19. The electric motors 19 are coupled to the wheels 18 through a vehicle transmission, such that rotation of the electric motor 19 (e.g., rotation of a drive shaft of the motor) rotates a transmission shaft, which in turn rotates the wheels 18 of the vehicle. In other embodiments, the vehicle 10 is powered by an internal combustion engine. The batteries 20 also supply electrical power to additional subsystems on the vehicle 10, including additional electric motors, cab controls (e.g., climate controls, steering, lights, etc.), a boom assembly 30, and/or auxiliary systems, for example.

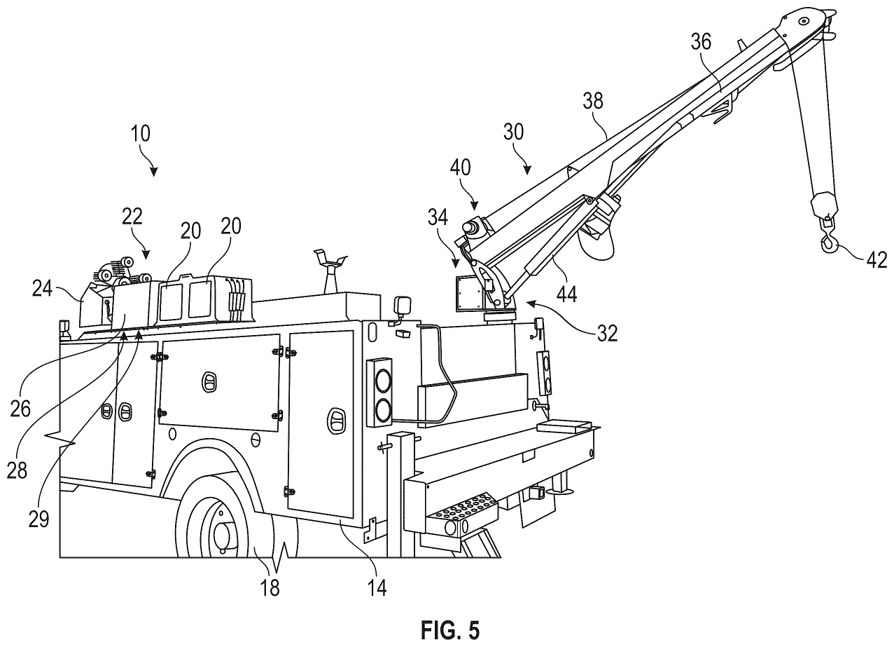

According to an exemplary embodiment, the vehicle 10 includes a boom assembly 30 (e.g., a vehicle-mounted crane, a boom assembly, etc.) is configured to lift and move a load relative to the vehicle 10 for a variety of purposes. The load is typically heavy and/or large and may be, for example, cargo, materials, components, machines, goods, etc. The vehicle 10 typically includes the main body 14 (e.g., platform, etc.) and the boom assembly 30 (shown in FIGS. 2 and 5) extending from the main body 14. The main body 14 may be fixed or mobile. The boom assembly 30 is coupled to the main body 14 via a boom assembly mount 32 comprising a mounting flange and coupling members (e.g., bolts, screws, etc.). The boom assembly 30 also comprises a boom base 34 coupled to the boom assembly mount 32 and a boom arm 36 extending from the boom base 34. The boom assembly 30 supports a cable 38, which may be formed from metal wire, chains, rope, or other materials. A hoist 40 (e.g., a winch, an electric hoist, etc.) is used to wind (e.g., retract) and unwind (e.g., extend) the cable. The boom assembly 30 further includes a hook 42 or other tool hanging from the end of the boom assembly 30 opposite to the boom assembly mount 32 by the cable 38. The hook 42 is generally used to attach the cargo, materials, or other items to the cable 38 of the boom assembly 30. In some embodiments, the boom assembly 30 may include the hook 42 or other tool fastened to a rigid post or section, without the cable 38.

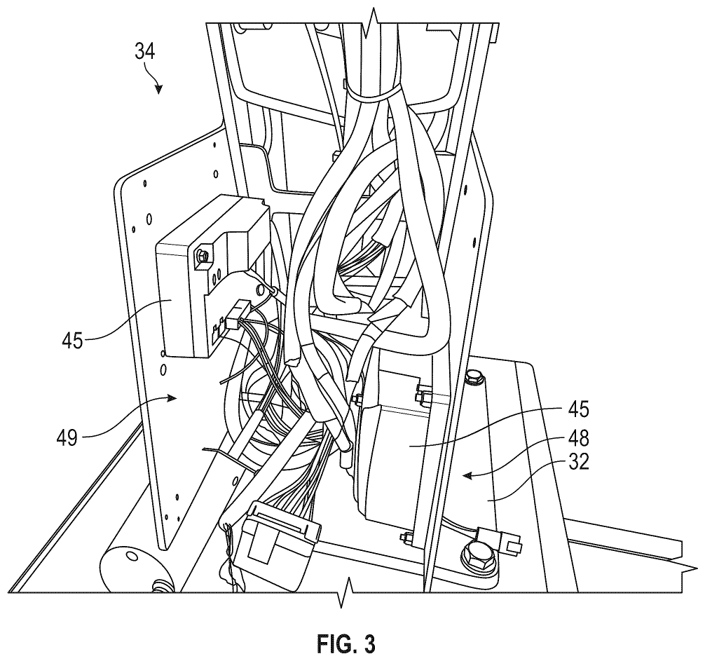

The boom assembly 30 includes one or more electric actuators and/or one or more electric motors 43. For example, the electric actuators may be used for primary functions of the boom assembly 30 and extension functions of the boom assembly 30, while the electric motors 43 may be used for rotation functions and hoist or lifting functions of the boom assembly 30. As further shown in FIGS. 2 and 5, the boom assembly 30 includes a lift actuator 44 extending between the boom base 34 and the boom arm 36. Within the boom base 34 are one or more motor controller modules 45, shown in FIG. 3, although in some embodiments, the one or more motor controller modules 45 may be located elsewhere. The one or more motor controller modules 45 can include controller modules for the lift actuator 44, an extension actuator 46, and a rotation motor 48. The lift actuator 44 provides power to the boom assembly 30 for the lifting functions of the boom assembly 30, such as to adjust an angular orientation of the boom arm 36 relative to the main body or a ground surface. The extension actuator 46 provides power to the boom assembly 30 for the extension functions of the boom assembly 30, such as to extend the length of the boom arm 36. The rotation motor 48 provides power to allow the boom base 34 and the boom arm 36 to rotate about an axis (e.g., the axis at the coupling point of the boom assembly mount 32 and the main body 14). Also contained within the boom base 34 may be power quick-connects for the lift actuator 44 and the extension actuator 46. For example, the boom base 34 may include a power disconnect block 49 for high voltage and/or low voltage connections.

In the embodiment shown, the main body 14 of the vehicle 10 includes an Electrified Power Equipment (EPEQ) system 22 provided within an EPEQ housing onboard the vehicle. The EPEQ system 22 may be coupled to a vehicle chassis and/or the body assembly 12 (e.g., the main body 14). In the embodiment shown, the EPEQ system 22 is coupled to a cargo body portion of the body assembly 12 (e.g., the main body 14) that includes a cargo carrier (e.g., a cargo cabinet, a toolbox, etc.). The EPEQ system 22 is engaged with and extends along an upper wall of the cargo carrier. Such an arrangement can improve access to components of the EPEQ system 22 and can enable removal and replacement of the EPEQ system 22 and components thereof without having to disassemble other vehicle subsystems or body components

In the embodiment shown, the main body 14 of the vehicle 10 supports a primary battery (e.g., the batteries 20, etc.) that is configured to supply electrical power to the various systems on the body assembly 12 of the vehicle 10. In some embodiments, the batteries are also configured to supply power to the prime mover (e.g., motors powering movement of the wheels). In some embodiments, the EPEQ system 22 also includes a power distribution unit (PDU) in communication with the batteries 20 that is configured to selectively monitor and supply electrical power from the batteries 20 to each of the boom assembly 30 and/or the prime mover. The PDU can be a controller, processor, central processing unit (CPU), or other type of programmable or non-programmable device that monitors the batteries 20 and the systems on the body assembly 12 and chassis that request electrical power from the batteries 20. The PDU is configured to control the supply of electrical power from the batteries 20 to accommodate the power requests of the various systems on the chassis and body assembly 12 of the vehicle 10. The PDU monitors the batteries 20 and controls contactors within the batteries 20 to direct electrical power to the various systems within the vehicle 10. In some examples, the PDU prioritizes electrical power delivery through the vehicle 10. The PDU can ensure that critical functions (e.g., the prime mover, etc.) receive electrical power before the auxiliary systems, like the climate control systems, or radio, for example.

The PDU can control the supply electrical power from the batteries 20 to the body assembly 12. In some examples, a disconnect (discussed further herein) is positioned between the PDU and the body assembly 12 to selectively disable electrical power transmission from the batteries 20 to the body assembly 12. In some embodiments, the disconnect may be stored in the boom base 34. The disconnect provides selective electrical communication between the batteries 20 and the body assembly 12 that can allow the secondary vehicle systems (e.g., the boom assembly 30, etc.) to be decoupled and de-energized from the electrical power source. The disconnect can create an open circuit between the batteries 20 and the body assembly 12, such that no electricity is supplied from the batteries 20 to the various systems on the vehicle 10. The vehicle 10 can then be operated in a lower power consumption mode, given the reduced electrical load required from the batteries 20 to operate the vehicle 10. The disconnect further enables the vehicle 10 to conserve energy when the vehicle subsystems are not needed, and can also be used to lock out the various vehicle subsystems to perform maintenance activities.

### Electrical System

The vehicle 10 includes an electrical system (e.g., the EPEQ system 22) or power distribution system for providing electrical energy. The electrical system is configured to deliver electrical energy throughout the vehicle 10, and switch power between various energy sources (e.g., the batteries 20, the charger 29, etc.). The electrical energy delivered by the electrical system may be provided by the batteries 20. Additionally or alternatively, the electrical energy delivered by the electrical system may be provided by a shore power inlet, shown as the charger 29. The charger 29 may be selectively electrically coupled to an external energy source (e.g., a power grid, a generator, a charging station, etc.) to deliver electrical energy to the vehicle 10 to charge the batteries 20 and/or directly power one or more components of the vehicle 10.

The EPEQ system 22 includes a power distribution device, shown as the electric power control box 26. The electric power control box 26 is configured to control the distribution of electrical energy throughout the vehicle 10. The electric power control box 26 is electrically coupled to voltage components of the power distribution system through one or more cables or wires. The cables or wires electrically couple the electric power control box 26 to the batteries 20, the charger 29, and the one or more electric motors 19, 43, 48 and/or one or more electric actuators 44, 46. The electric power control box 26 transfers electrical energy from energy sources (e.g., the batteries 20, the charger 29, etc.) to energy consumers (e.g., the one or more electric motors 19, 43, 48, the one or more electric actuators 44, 46, etc.). The electric power control box 26 may direct electrical energy from the charger 29 to the batteries 20 to charge the batteries 20, or directly from the charger 29 to the one or more electric motors 19, 43, 48 and/or the one or more electric actuators 44, 46.

In some embodiments, the electric power control box 26 includes a switch, contactor, or power disconnect (e.g., a service disconnect, etc.). The service disconnect selectively electrically couples the batteries 20 and the charger 29 to the energy consumers downstream of the electric power control box 26. When disengaged, the service disconnect electrically isolates the charger 29 and the batteries 20 from the downstream energy consumers. In some embodiments, each of the batteries 20 also includes a switch, contactor, or power disconnect (e.g., a battery disconnect, etc.). The battery disconnect selectively electrically couples the corresponding battery 20 with the electric power control box 26. When disengaged, the battery disconnect electrically isolates the corresponding battery 20 from the rest of the electrical system.

The electric power control box 26 is electrically coupled to the one or more electric motors 19, 43, 48 and/or the one or more electric actuators, such as the lift actuator 44 and the extension actuator 46, by one or more power electronics or power conversion devices, shown as the body power inverter 28. The body power inverter 28 may be configured to convert direct current (DC) electrical energy from the electric power control box 26 to alternating current (AC) electrical energy. The body power inverter 28 may facilitate the use of AC electrical motors as the one or more motors 19, 43, 48.

The batteries 20, the one or more electric motors 19, 43, 48, the one or more actuators 44, 46, the charger 29, and the electric power control box 26 may at least partially form a high voltage portion of the electrical system. In some embodiments, the EPEQ system 22 further includes a power conversion device or power conditioner (e.g., a DC/DC converter, etc.) is configured to receive high voltage electrical energy from the electric power control box 26 and provide electrical energy at a low voltage to a low voltage portion of the electrical system. By way of example, the low voltage portion of the electrical system may operate on 24V DC electrical energy. The low voltage electrical energy may be distributed through one or more cables or wires. In some embodiments, components that are part of the low voltage portion of the electrical system are instead part of the high voltage portion (e.g., a high voltage portion operating at 48V). In some embodiments, components that are part of the high voltage portion of the electrical system are instead part of the low voltage portion.

The electrical system includes the one or more electric motors 19, 43, 48 and additional motors (e.g., a steering motor, a boom cable lift motor, etc.) that may be part of the high voltage portion of the electrical system. The one or more electric motors may be configured to receive electrical energy and provide a mechanical energy output (e.g., a torque, a pressurized fluid, etc.). In some embodiments, the one or more electric motors may be configured to steer the vehicle 10 (e.g., by rotating the wheels 18, by providing a flow of pressurized power steering fluid, etc.).

The EQEP system 22 may include one or more input devices (e.g., sensors, cameras, etc.) that are powered by electrical energy from the batteries 20. The one or more input devices may be part of the low voltage portion of the electrical system. The one or more input devices may provide sensor data concerning operation of the vehicle 10 (e.g., the boom assembly 30) to the controllers. By way of example, the sensors may include accelerometers, encoders, buttons, switches, potentiometers, load cells, global positioning systems (GPS), and/or other types of sensors.

The electrical system also may include one or more output devices (e.g., lights for the vehicle 10 such as headlights or cab interior lights, heaters, etc.) that may operate on the low voltage portion of the electrical system. The one or more output devices may be configured to provide an output in response to receiving electrical energy. For example, the lights of the vehicle 10 are configured to illuminate in response to receiving electrical energy. The lights may be used to illuminate an area (e.g., headlights, fog lights, spotlights, etc.). The lights may be used to convey information to individuals in the surroundings (e.g., turn signals, brake lights, reverse lights, etc.). The lights may be used to illuminate the cab 16 (e.g., overhead lights, door lights, dashboard lights, etc.). As another example, the vehicle 10 may include a battery heater and/or a cab heater. The battery heater and the cab heater are configured to provide thermal energy in response to receiving electrical energy. The battery heater is coupled to one or more of the batteries 20 and is configured to provide thermal energy to heat the one or more of the batteries 20. The cab heater is coupled to the cab 16 and configured to heat the interior of the cab 16.

The electrical system includes one or more processing circuits (e.g., controllers, etc.) that receive electrical energy and control operation of one or more systems of the vehicle 10. The one or more processing circuits may be part of the low voltage portion of the electrical system. The one or more processing circuits may include one or more processors and one or more memory devices. The one or more memory devices may contain one or more instructions that, when executed by the one or more processors, cause the one or more processing circuits to perform one or more of the operations described herein.

With continued reference to FIGS. 1-5, the vehicle 10 (e.g., the EPEQ system 22) may include the disconnect. The disconnect provides selective electrical communication from the batteries 20 that can allow the secondary vehicle systems and subsystems (e.g., the boom assembly 30, etc.) to be decoupled and de-energized from the electrical power source. The disconnect can create an open circuit between the batteries 20 and other vehicle systems of the vehicle 10, such that no electricity is supplied from the batteries 20. The vehicle 10 can then be operated in a lower power consumption mode, given the reduced electrical load required from the batteries 20 to operate the vehicle 10. The disconnect further enables the vehicle 10 to conserve energy when the vehicle subsystems are not needed, and can also be used to lock out the various vehicle subsystems to perform maintenance activities.

FIGS. 1, 4, and 5 depict the electric power control box 26 that can include and/or function as the disconnect. The electric power control box 26 generally includes a housing having a cover or door that together define a waterproof or semi-waterproof cavity. The waterproof cavity receives and supports electrical connections between the batteries 20 and other systems of the vehicle 10 (e.g., the boom assembly 30) to create a selective electrical coupling between the batteries 20 and the other system(s). Fittings are positioned about the perimeter of the housing and define passages through the housing to receive electrical inputs. The fittings can be rigidly coupled (e.g., welded) or removably coupled (e.g., threaded) to the housing so that a water-tight seal is formed between the fittings and the housing. In some examples, a low voltage connector tube extends through the housing and into the cavity as well. The housing is configured to be mounted to the body assembly 12 of the vehicle 10. The housing may include a mounting flange extending around at least a portion of the housing and including a plurality of mounting holes that can be used to fasten the housing to the body assembly 12 of the vehicle 10. In some examples, a vent is formed within an underside of the housing to allow cooling air to enter into the cavity.

The controller 27 can initiate electrical power transfer between the batteries 20 and the other systems of the vehicle 10. In some examples, the controller 27 monitors the position of the disconnect. For example, the controller 27 can receive information from one or more disconnect feedback lines to determine whether the disconnect is in the open or closed position. If the controller 27 determines that the disconnect is open, the controller 27 can issue a command to open a contactor switch within a negative high voltage contactor. An auxiliary low voltage source can then toggle the contactor switch open. In some examples, the controller 27 also communicates with the batteries 20 and the associated circuit(s) to open contactors associated with the batteries 20 to further isolate the batteries 20 from other systems. Similarly, the controller 27 can control the electric power control box 26 so that the contactor switch within the negative high voltage contactor closes whenever the controller 27 determines that the disconnect is closed.

The controller 27 communicates with the batteries 20 (e.g., to the PDU of the chassis in communication with the batteries 20, to a power conditioner (e.g., a DC to DC converter or other power conditioners for supplying power from the batteries 20 to the lift actuator 44 or motors of the boom assembly 30, an inverter for converting power from the batteries to operate an electric motor for the winch (in an AC motor arrangement), to the disconnect, etc.) to initiate the transmission of electrical power from the batteries 20 to and through the electric power control box 26. In some examples, the controller 27 communicates a detected voltage at an inverter (e.g., the body power inverter 28, etc.) providing power to electrical functions of the boom assembly 30, which can indicate whether or not the disconnect is open or closed. If the contactor switch within the negative high voltage contactor is open, the controller 27 can communicate with the batteries 20 to ensure that the contactor switches associated with the batteries 20 are open as well. Accordingly, no high voltage will be provided from the batteries 20 to the electric power control box. If the controller 27 requests the contactors within the PDU of the batteries 20 to open, but confirmation that the contactors are open is not received by the controller 27, the controller 27 will prevent the negative high voltage contactor and associated switch from closing. Closing the negative high voltage contactor before pre-charging the negative high voltage high voltage contactor could couple the batteries 20 to the electric power control box in a way that might otherwise cause an inrush current that could weld the contactors or even blow a main fuse within the inverter. Accordingly, this condition is preferably avoided by the controller 27, and the electric power control box, more generally.

### Power Distribution and Management

The vehicle 10 can also include several power saving or power generation features to help further extend the life of the batteries 20 and extend the performance time of the vehicle 10. The vehicle 10 is configured to execute a variety of different location-based and condition-based processes that can link data received or generated by the body assembly 12 to the prime mover and batteries 20 to help perform different functions of the vehicle 10. For example, the vehicle 10 can include the GPS that is positioned within the cab 16 or elsewhere upon the body assembly 12 to monitor a current location of the vehicle 10. The GPS communicates with the controller 27 which can, based upon the detected location of the vehicle 10, modify vehicle performance by activating, deactivating, or optimizing different vehicle subsystems. The controller 27 communicates with the memory and/or the network to access information in real time corresponding to desired performance characteristics associated with a location of the vehicle 10. Similarly, the vehicle 10 (and GPS) can include a series of condition sensors that are configured to detect one or more of weather conditions, traffic conditions, roadway conditions, and/or other collectable data along a route or in a certain location. The vehicle 10 can once again communicate the data from the GPS and associated sensors to the controller 27, which can then execute a series of commands that modify the amount or distribution of electrical power sent from the batteries 20 to the body assembly 12 to control the vehicle 10.

As another example, the HVAC can be significantly simplified to reduce the number of pumps or compressors within the system. In some examples, the HVAC within the body assembly 12 (and the cab 16, specifically) is in communication with the controller 27, the PDU, and the batteries 20. The HVAC can be a single integrated thermal management system that is configured to supply heating, cooling, and air flow to the entire body assembly 12. Under normal or standard operating conditions, the HVAC can require a significant power draw from the batteries 20. The power draw necessary to achieve desired climate control conditions is amplified when ambient outdoor temperatures are very high or very low. To avoid excessive power draw from the batteries 20, the PDU and the controller 27 can be configured to reduce, limit, or disable the HVAC under certain operating conditions. For example, if the PDU communicates that the remaining battery life is low, the controller 27 can reduce the operation of the HVAC to partial functionality. For example, pumps and compressors within the HVAC may be disconnected from power but the fans can continue operating. If the remaining battery life continues to fall, the PDU and controller 27 can fully disable the HVAC so that the remaining battery life is conserved for use with the boom assembly 30.

The controller 27 and PDU are further configured to adjust the power distribution from the batteries 20 to the body assembly 12 based upon detected conditions within the batteries 20 or upon the vehicle 10, generally. The PDU is configured to prioritize the systems within the vehicle 10 so that electrical power from the batteries 20 is distributed to critical systems before auxiliary systems. In some examples, the vehicle 10 is configured to operate in a “limp home” mode. When the remaining battery life falls below a set threshold (e.g., 10 percent charge remaining, 5 percent charge remaining, etc.), the PDU and the controller 27 can communicate to block, disable, or limit the operation of the different systems upon the body assembly 12. The HVAC can be limited or temporarily disabled, the electric motors 19, 43, 48 can be halted, and the auxiliary systems can be disconnected from the batteries 20. In some examples, the vehicle 10 is configured with two tiers of reduced operation. For example, when the remaining charge on the batteries 20 falls below a first threshold (e.g., 10 percent), functionality of the auxiliary systems are reduced. The GPS, for example, can continue to monitor the location of the vehicle 10 and can communicate with the controller 27 and PDU to allow for limited operation of the boom assembly 30 upon determining that the vehicle 10 is positioned within or at a certain location. If the remaining battery power falls below a second threshold (e.g., 5 percent), the PDU can reduce power supply from the batteries 20 to the body assembly 12 so that only the prime mover and the cab controls (e.g., the dashboard and steering) remain operational until the vehicle 10 is reconnected to the power source. The PDU can limit the acceleration curve and/or maximum output of the prime mover to further conserve battery power.

In some examples, the vehicle 10 is configured to include supplemental power supplies and/or energy saving devices. For example, one or more solar panels can be positioned along the body assembly 12. In some embodiments, solar panels extend along a top of the cab 16 and/or the main body 14. The solar panels can capture solar energy, which can be converted into usable battery power that can be stored and/or used by the batteries 20. Additionally or alternatively, the vehicle 10 can be outfitted with regenerative brakes. The brakes can harvest rotational energy or heat generated by the brakes while the vehicle 10 drives so that battery power can is conserved. The brakes can resupply the energy captured to the PDU or to the batteries 20.

### Electric Crane Arrangement

As shown in FIGS. 1, 4, and 5, the main body 14 of the vehicle 10 supports the EPEQ system 22 including the batteries 20, the electric power control box 26, the body power inverter 28, and the charger 29. The main body 14 also supports the air compressor 24. The batteries 20, the air compressor 24, the electric power control box 26, the body power inverter 28, and the charger 29 are positioned inline and are arranged along a top surface of the main body 14 proximate to a side of the main body 14 (e.g., the driver's side of the vehicle 10, etc.) and positioned substantially in between the cab 16 and the boom assembly 30. The air compressor 24 is positioned towards a front portion of the main body 14, proximate to the cab 16. The electric power control box 26, the body power inverter 28, and the charger 29 are proximate to the air compressor 24. The batteries 20 are proximate to the electric power control box 26. The batteries 20 are configured as two batteries 20 positioned inline and contained within a housing, but the batteries 20 may be configured in another manner and may not include the housing. In other embodiments, the above-referenced components may be arranged in any other order or manner on the vehicle 10. Positioning the various components of the EPEQ system 22 within the electric power control box 26 can simplify maintenance and enable installation and/or removal of the EPEQ system 22 as a single module. Such an arrangement can also simplify retrofit of the vocational vehicle to include the all-electric boom assembly 30. Such an arrangement also enables replacement or maintenance of the batteries 20, which are located in a separate enclosure from the electric power control box 26 separately from other components of the EPEQ system 22. In some embodiments, the electric power control box 26 may not contain the body power inverter 28 or the charger 29, which may be stored in a separate enclosure along the main body 14. In some embodiments, the power inverter 28 may be stored within the boom base 34.

Although the description of the EPEQ system 22 and the batteries 20 have been described within the context of the vehicle 10 of FIGS. 1 and 5, the same or similar systems can also be included on other vehicle structures and configurations without significant modification. For example, the EPEQ system 22 and/or batteries 20 could be located at other positions along the vehicle 10 in other embodiments. Accordingly, the disclosure should be considered to encompass the electrical system and the disconnect in isolation and incorporated into any type or variation of crane or vehicle.

The boom assembly 30 is configured as an all-electric boom assembly (e.g., an all-electric crane) that does not require the use of hydraulic fluids to power actuation. The boom assembly 30 is coupled to the main body 14 via a boom assembly mount 32 comprising a mounting flange and coupling members (e.g., bolts, screws, etc.). The boom assembly 30 also comprises a boom base 34 coupled to the boom assembly mount 32 and a boom arm 36 extending from the boom base 34. The boom assembly 30 supports a cable 38, which may be formed from metal wire, chains, rope, or other materials. A hoist 40 (e.g., a winch, an electric hoist, etc.) is used to wind (e.g., retract) and unwind (e.g., extend) the cable. The boom assembly 30 further includes a hook 42 or other tool hanging from the end of the boom assembly 30 opposite to the boom assembly mount 32 by the cable 38. In some embodiments, the hoist 40 includes an electric motor that is configured to power movement of the hook 42 or other implement. The electric motor may be configured to retract or extend the cable from a spool of the boom assembly. The hook 42 is generally used to attach the cargo, materials, or other items to the cable 38 of the boom assembly 30. In some embodiments, the boom assembly 30 may include the hook 42 or other tool fastened to a rigid post or section, without the cable 38.

A method of manufacturing a vehicle according to the description herein may include several processes. The method may include coupling a boom assembly comprising an electric actuator and an electric motor to a main body of a vehicle and supporting the main body by a chassis of the vehicle. Additionally, the method may include coupling an electrical accessory equipment system to the main body and the boom assembly. The electrical accessory equipment system may include one or more batteries and an electric power control box housing a power conditioner that is configured to supply power from the one or more batteries to the electric actuator and/or the electric motor.

In some embodiments, the method may include additional processes such as coupling the electric power control box to the main body so that the electrical accessory equipment system is positioned inline and arranged along a top surface of the main body, proximate to a side of the main body, and between the cab and the boom assembly. Coupling the electrical accessory equipment system to the boom assembly may include electrically coupling a power conditioner of the electrical accessory equipment system to the boom assembly and the one or more batteries.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the crane as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A vehicle comprising:
a chassis supporting a plurality of wheels;
a prime mover supported by the chassis;
a vehicle body supported by the chassis and comprising a main body and a cab;
a boom assembly coupled to the main body, the boom assembly comprising an electric actuator and an electric motor; and
an electrical accessory equipment system coupled to the main body, the electrical accessory equipment system comprising:
one or more batteries; and
an electric power control box housing a power conditioner that is configured to supply power from the one or more batteries to the electric actuator and/or the electric motor.

2. The vehicle of claim 1, wherein the electric power control box, and the one or more batteries are positioned inline and are arranged along a top surface of the main body, proximate to a side of the main body, and positioned substantially in between the cab and the boom assembly.

3. The vehicle of claim 1, wherein the electric power control box comprises one or more of a power distribution unit, a body power inverter, or a charger.

4. The vehicle of claim 1, further comprising a power distribution unit that is communicatively coupled with the one or more batteries and configured to selectively monitor and supply electrical power from the one or more batteries to each of the electric actuator and the electric motor.

5. The vehicle of claim 1, wherein the power distribution unit is configured to prioritize systems within the vehicle and distribute electrical power from the one or more batteries to critical systems before auxiliary systems.

6. The vehicle of claim 3, wherein the body power inverter is in electrical energy providing communication from the one or more batteries to a system of the vehicle that is separate from the electric actuator and the electric motor.

7. The vehicle of claim 1, wherein the electric power control box is configured to selectively electrically couple the one or more batteries to one or more energy consuming components downstream of the electric power control box.

8. The vehicle of claim 1, wherein the boom assembly comprises a boom base and a boom arm, the actuator configured to adjust an angular orientation of the boom arm, the motor configured to rotate the boom base.

9. A mobile crane system for a vocational vehicle, the mobile crane system comprising:
a boom assembly configured to be coupled to the vocational vehicle, the boom assembly comprising an electric actuator and an electric motor;
an electrical accessory equipment system configured to be coupled the vocational vehicle, the electrical accessory equipment system comprising:
one or more batteries; and
an electric power control box housing a power conditioner that is configured to supply power from the one or more batteries to the electric actuator and/or the electric motor.

10. The vehicle system of claim 9, wherein the electrical accessory equipment system is configured to be coupled to the vocational vehicle remote from the boom assembly.

11. The vehicle system of claim 9, wherein the controller is communicatively coupled with a power distribution unit to initiate the transmission of electrical power from the one or more batteries to and through the electric power control box.

12. The vehicle system of claim 9, wherein the electrical accessory equipment system further comprises an air compressor, and wherein the electrical accessory equipment system is configured to supply power from the one or more batteries to the air compressor.

13. The vehicle system of claim 9, wherein the electric power control box comprises one or more of a power distribution unit, a body power inverter, or a charger.

14. The vehicle system of claim 13, wherein the power distribution unit is configured to prioritize systems within the electric crane vehicle and distribute electrical power from the one or more batteries to critical systems before auxiliary systems.

15. The vehicle system of claim 13, wherein the body power inverter is in electrical energy providing communication from the one or more batteries to a system of the electric crane vehicle.

16. The vehicle system of claim 9, wherein the electric power control box is configured to selectively electrically couple the one or more batteries to one or more energy consuming components downstream of the electric power control box.

17. The vehicle system of claim 9, wherein the boom assembly comprises a boom base and a boom arm, the actuator configured to adjust an angular orientation of the boom arm, the motor configured to rotate the boom base.

18. A method of manufacturing a vehicle comprising:
coupling a boom assembly comprising an electric actuator and an electric motor to a main body of a vehicle, the main body supported by a chassis of the vehicle;
coupling an electrical accessory equipment system to the main body and the boom assembly, the electrical accessory equipment system comprising:
one or more batteries; and
an electric power control box housing a power conditioner that is configured to supply power from the one or more batteries to the electric actuator and/or the electric motor.

19. The method of claim 18, wherein coupling the electrical accessory equipment system to the main body comprises coupling the electric power control box to the main body so that the electrical accessory equipment system is positioned inline and arranged along a top surface of the main body, proximate to a side of the main body, and between the cab and the boom assembly.

20. The method of claim 18, wherein coupling the electrical accessory equipment system to the boom assembly comprises electrically coupling a power conditioner of the electrical accessory equipment system to the boom assembly and the one or more batteries.
